(19) United States
(12) Patent Application Publication
(10) Pub. No.: US 2012/0044179 A1
(43) Pub. Date: Feb. 23, 2012

(54) TOUCH-BASED GESTURE DETECTION FOR A TOUCH-SENSITIVE DEVICE

(75) Inventor: Douglas T. Hudson, Bayville, NJ (US)

(73) Assignee: Google, Inc., Mountain View, CA (US)

(21) Appl. No.: 13/212,083

(22) Filed: Aug. 17, 2011

Related U.S. Application Data
(60) Provisional application No. 61/374,519, filed on Aug. 17, 2010.

(51) Int. Cl. G06F 3/041

(52) U.S. Cl. 345/173

(57) ABSTRACT

This disclosure is directed to techniques for improved detection of user input via a touch-sensitive surface of a touch-sensitive device. A touch-sensitive device may detect a continuous gesture that comprises a first gesture portion and a second gesture portion. The first gesture portion may indicate functionality to be initiated in response to the continuous gesture. The second gesture portion may indicate content for which the functionality indicated by the first gesture portion is based. Detection that a user has completed a continuous gesture may cause automatic initiation of the functionality indicated by the first gesture portion based on the content indicated by the second gesture portion. In one specific example, the first gesture portion indicates that the user seeks to perform a search, and the second gesture portion indicates content to be searched.

### RELATED APPLICATIONS

This application claims the benefit of priority to U.S. Provisional Application No. 61/374,519, filed Aug. 17, 2010, the entire content of which is incorporated by reference herein.

### TECHNICAL FIELD

This disclosure relates generally to electronic devices and, more specifically, to input mechanisms for user communications with a touch-sensitive device.

### BACKGROUND

Known touch-sensitive devices enable a user to provide input to a computing device by interacting with a display or other surface of the device. The user may initiate functionality for the device by touch-based selection of icons or links provided on a display of the device. In other examples, one or more non-display portions (e.g., a touch pad or device casing) of a device may also be configured to detect user input.

To enable detection of user interaction, touch-sensitive devices typically include an array of sensor elements arranged at or near the detection surface. The detection elements provide one or more signals in response to changes in physical characteristics caused by user interaction with a display. These signals may be received by one or more circuits of the device, such as a processor, and control device functionality in response to touch-based user input. Examples technologies that may be used to detect physical characteristics caused by a finger or stylus in contact with a detection surface may include capacitive (both surface and projected capacitance), resistive, surface acoustic wave, strain gauge, optical imaging, dispersive signal (e.g., mechanical energy in glass detection surface that occurs due to touch), acoustic pulse recognition (e.g., vibrations caused by touch), coded LCD (Bidirectional Screen) sensors, or any other sensor technology that may be utilized to detect a finger or stylus in contact with or in proximity to a detection surface of a touch-sensitive device.

To interact with a touch-sensitive device, a user may select items presented via a display of the device to cause the device to perform functionality. For example, a user may initiate a phone call, email, or other communication by selecting a particular contact presented on the display. In another example, a user may view and manipulate content available via a network connection, e.g., the Internet, by selecting links and/or typing a uniform resource identifier (URI) address via interaction with a display of the touch-sensitive device.

### SUMMARY

The instant disclosure is directed to improvements in user control of a touch-sensitive device by enabling a user to, via continuous gestures detected via a touch-sensitive surface of the device, indicate functionality to be performed by a first portion of the continuous gesture and to indicate content associated with the functionality indicated with the first portion of the continuous gesture by a second portion of the continuous gesture.

In one example, a method is provided herein consistent with the techniques of this disclosure. The method includes detecting user contact with a touch-sensitive device. The method further includes detecting a first gesture portion while the user contact is maintained with the touch-sensitive device, wherein the first gesture portion indicates functionality to be performed. The method further includes detecting a second gesture portion while the user contact is maintained with the touch-sensitive device, wherein the second gesture portion indicates content to be used in connection with the functionality indicated by the first gesture. The method further includes detecting completion of the second gesture portion. The method further includes initiating the functionality indicated by the first gesture portion in connection with the content indicated by the second gesture portion.

In another example, a touch-sensitive device is provided herein consistent with the techniques of this disclosure. The device includes a display configured to present at least one image to a user. The device further includes a touch-sensitive surface. The device further includes at least one sense element disposed at or near the touch-sensitive surface and configured to detect user contact with the touch-sensitive surface. The device further includes means for determining a first gesture portion while the at least one sense element detects the user contact with the touch-sensitive surface, wherein the first gesture portion indicates functionality that is to be initiated. The device further includes means for determining a second gesture portion while the at least one sense element detects the user contact with the touch-sensitive surface, wherein the second gesture portion indicates content to be used in connection with the functionality indicated by the first gesture. The device further includes means for initiating the functionality indicated by the first gesture portion in connection with the content indicated by the second gesture portion.

In another example, an article of manufacture comprising a computer-readable storage medium that includes instructions that, when executed, cause a computing device to detect user contact with a touch-sensitive device. The instruction, when executed, further cause the computing device to detect a first gesture portion while the user contact is maintained with the touch-sensitive device, wherein the first gesture portion indicates functionality to be performed. The instruction, when executed, further cause the computing device to detect a second gesture portion while the user contact is maintained with the touch-sensitive device, wherein the second gesture portion indicates content to be used in connection with the functionality of the first gesture. The instruction, when executed, further cause the computing device to detect completion of the second gesture portion. The instruction, when executed, further cause the computing device to initiate the functionality indicated by the first gesture portion in connection with the content indicated by the second gesture portion.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating one example of user interaction with a display of a touch-sensitive device consistent with the techniques of this disclosure.

FIG. 2 is a block diagram illustrating components of a touch-sensitive device that may be configured to detect a continuous gesture consistent with the techniques of this disclosure.

FIG. 3 is a block diagram illustrating components configured to detect a continuous gesture consistent with the techniques of this disclosure.

FIGS. 4A-4F are a conceptual diagrams illustrating various examples of continuous gestures consistent with the techniques of this disclosure.

FIGS. 5A-5B are a conceptual diagrams illustrating examples of continuous gestures that may indicate functionality associated with text and/or photo content consistent with the techniques of this disclosure.

FIG. 6 is a conceptual diagram illustrating examples of detecting a continuous gesture that indicates selection of multiple content consistent with the techniques of this disclosure.

FIG. 7 is a conceptual diagram illustrating one example of providing a user with options based on detection of a continuous gesture consistent with this disclosure.

FIGS. 8A-8B are conceptual diagrams illustrating various examples of resolving ambiguity in detection of a continuous gesture consistent with the techniques of this disclosure.

FIG. 9 is a flow chart diagram illustrating one example of a method of detecting a continuous gesture consistent with the techniques of this disclosure.

### DETAILED DESCRIPTION

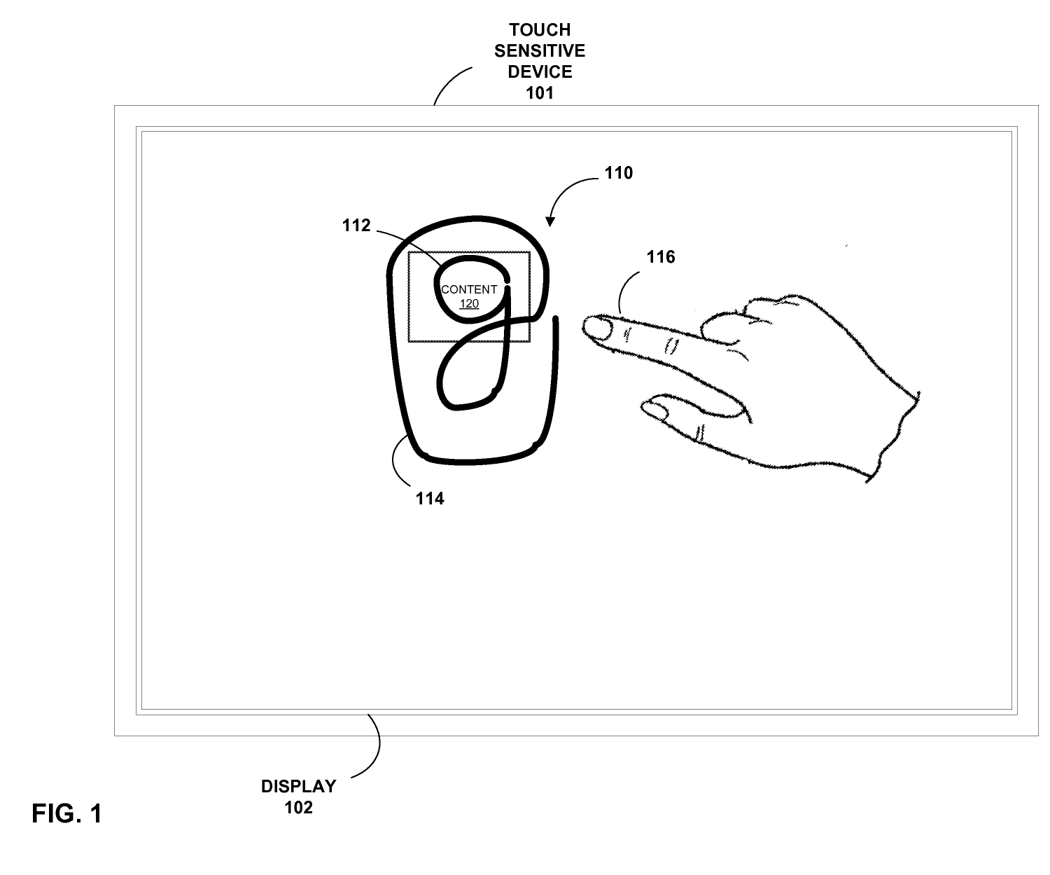

FIG. 1 is a block diagram illustrating one example of a touch-sensitive device 101. The device 101 includes a display 102 for presenting images to a user of the device. In addition to presenting images, display 102 is further configured to detect touch based input from a user. The user may initiate functionality for the device and input content by interacting with display 102.

Examples of touch-sensitive devices as described herein include smart phones and tablet computers (e.g., the iPad® available from Apple Inc.®, the Slate® available from Hewlett Packard®, the Xoom® available from Motorola, the Transformer® available from Asus, and the like). Other devices may also be configured as touch-sensitive devices. For example, desktop computers, laptop computers, netbooks, and smartbooks often employ a touch-sensitive track pad that may be used to practice the techniques of this disclosure. In other examples, a display of a desktop, laptop, netbook, or smartbook computer may also or instead be configured to detect touch. Television displays may also be touch-sensitive. Any other device configured to detect user input via touch may also be used to practice the techniques described herein. Furthermore, devices that incorporate one or more touch-sensitive portions other than a display of the device may be used to practice the techniques described herein.

Known touch-sensitive devices provide various advantages over their classical keyboard and trackpad/mouse counterparts. For example, touch-sensitive devices may not include an external keyboard and/or mouse/trackpad for user input. As such, touch-sensitive devices may be more portable than their keyboard/mouse/touchpad counterparts. Touch-sensitive devices may further provide for a more natural user experience than classical computing devices, because a user may interact with the device by simple pointing and drawing as a user would interact with a page of a book or document when communicating with another person.

Many touch-sensitive devices are designed to minimize a need for external device buttons for device control, in order to maximize screen or other component size, while still providing a small and portable device. Thus, it may be desirable to provide input mechanisms for a touch-sensitive device that, for the most part, rely primarily on user interaction with via touch to detect user input to control operations of the device.

Due to dedicated buttons (e.g., on a keyboard, mouse, or trackpad), classical computing systems may provide a user with more options for input. For example, a user may use a mouse or trackpad to “hover” over an object (icon, link) and select that object to initiate functionality (open a browser window to link a dress, open document for editing). In this case, functionality is tied to content, meaning that a single operation (selecting an icon with a mouse button click) selects a web site for viewing, and opens the browser window to view the content for that site. In other examples, a user may use a keyboard to type in content or, with a mouse or trackpad, select content (a word or phrase) and identify that content for another application (e.g., copy and paste text into a browser window) to initiate functionality based in content where the user desires to use content for functionality that is not directly tied to the content as described above. According to these examples, a user is provided with more flexibility, because the content is not tied to particular functionality.

Touch-sensitive devices present problems with respect to the detection of user input that are not present with more classical devices as described above. For example, if a user seeks to select text via a touch-sensitive device, it may be difficult for the user to pinpoint the desired text because the user's finger (or stylus) is larger than the desired text presented on the display. User selection of text via a touch-sensitive device may be even more difficult if text (or other content) is presented in close proximity with other content. For example, it may be difficult for a touch-sensitive device to accurately detect a user's intended input to highlight a portion of text of a news article presented via a display. Thus, a touch-sensitive device may be beneficial for more simple user input (e.g., user selection of an icon or link to initiate a function), but may be less suited for more complex tasks (e.g., a copy/paste operation).

As discussed above, for classical computing devices, a user may initiate operations based on content not tied to particular functionality rather easily, because using a mouse or trackpad to select objects presented via a display may be more accurate to detect user intent. Use of a classical computing device for such tasks may further be easier, because using a keyboard provides a user with specific external non-gesture mechanisms for initiating functionality (e.g., cntl-C, cntl-V for copy/paste operation, or dedicated mouse buttons for such functionality) that are not available for many touch-sensitive devices.

A user may similarly initiate functionality based on untied content via copy and paste operations on a touch-sensitive device. However, due to the above-mentioned difficulty in detecting user intent for certain types of input, certain complex tasks that are easy to initiate via a classical computing device are more difficult on a touch-sensitive device. For example, for each part of a complex task, a user may experience difficulty getting the touch-sensitive device to recognize input. The user may be forced to enter each step of a complex task multiple times before the device recognizes the user's intended input.

For example, for a user to copy and paste solely via touch screen gestures, the user must initiate editing functionality with a first independent gesture, select desired text with a second gesture, identify an operation to be performed (e.g., cut, copy, etc.), open the functionality they would like to perform (e.g., browser window opened to search page), select a text entry box, again initiate editing functionality, and select a second operation to be performed (e.g., paste). There is therefore opportunity, for each of the above-mentioned independent gestures needed to cause a copy and paste operation, for error in user input detection. This may make a more complex task, e.g., a copy and paste operation, quite cumbersome, time consuming, and/or frustrating for a user.

To address these deficiencies with detection of user input for more complex tasks, this disclosure is generally directed to improvements in the detection of user input for a touch-sensitive device. In one example, as shown in FIG. 1, a touch-sensitive device 101 is configured to detect a continuous gesture 110 on a touch-sensitive surface (e.g., display 102 of device 101 in FIG. 1), by a finger 116 or stylus. As used herein, the term “continuous gesture” (e.g., continuous gesture 110 in the example of FIG. 1) refers to a continuous gesture drawn on a touch sensitive surface and detected by a touch sensitive device in response to the drawn gesture. As such, the term “continuous gesture” refers to a gesture detected by a touch-sensitive device (e.g., device 101 in the example of FIG. 1). The continuous gesture 110 indicates both a function to be executed and content that execution of the function is based on. The continuous gesture 110 includes a first portion 112 that indicates the function to be executed. The continuous gesture 110 also includes a second portion 114 that indicates content in connection with the function indicated by first portion 112 of gesture 110.

The example of FIG. 1 shows one example of a touch-sensitive device 101 that includes a display 102 that is configured to be touch-sensitive. Display 102 is configured to present to a user images, e.g., text and/or other content such as icons, photos, media objects or video. By interacting with the display 102 using a finger 116 or stylus, a user may operate device 101. As the user interacts with display 102, such as by “drawing” on the display, the display may detect a user's gesture and reflect it on display.

FIG. 1 shows a user's finger has drawn a continuous gesture 110 that includes a first portion 112 indicating a character “g”. The first portion 112 may indicate particular functionality, for example the character “g” may represent functionality to perform a search via a search engine available at www.google.com. The example illustrated in FIG. 1 is merely one example of functionality that may be indicated by a first portion 112 of a continuous gesture 110. Other examples, including other characters indicating different functionality, or a “g” character indicating functionality other than a search via www.google.com, are also contemplated by the techniques of this disclosure.

As also shown in FIG. 1, a user has used finger 116 to draw a second portion 114 of continuous gesture 110 that substantially encircles, or lassos, content 120. Content 120 may be displayed via display 102, and the second portion 114 may completely, repeatedly or partially surround content 120. Although FIG. 1 shows continuous gesture 110 drawn by finger 116 directly on display 101 encircling content 120 presented on display 102, continuous gesture 110 may instead be drawn by user interaction with a touch-sensitive non-display surface of device 101, or another device entirely. In various examples, content 120 may be any image presented via display 102. For example, content 120 may be an image of text presented via display 102. In other examples, content 120 may be a photo, video, icon, link, or other image presented via display 102.

Gesture 110 may be continuous in the sense that first portion 112 and second portion 114 are detected while a user maintains contact with a touch-sensitive surface (e.g., display 102 of device 101 in the FIG. 1 example). As such, device 101 may be configured to detect user contact with the touch-sensitive surface, and also detect when a user has released contact with the touch-sensitive surface.

Device 101 is configured to detect the first 112 and second 114 portions of continuous gesture 110, and correspondingly initiate functionality associated with the first portion 112 based on the content indicated by the second portion 114. According to the example of FIG. 1, continuous gesture 110 may cause touch-sensitive device 101 to execute a Google search for content 120.

The example of a continuous gesture 110 as depicted in FIG. 1 may provide significant advantages for detection of user interaction with device 101. As described above, a user may, in some cases, initiate functionality, e.g., a search, based on content presented via display 102 by copying content 120, and pasting content 120 into a text entry box in a web browser open to the URL www.google.com. A user may instead locate a text entry box for the www.google.com search engine and manually type a desired search term associated with content 120. For known touch-sensitive devices, these tasks may be complex because the user may provide input that may be difficult to detect for a series of independent steps to initiate the search. Instead, to address the difficulty of a complex task utilizing the techniques of this disclosure, a user may indicate content to be searched and execute a search based on content with a continuous gesture 110 that may be easier to accurately detect.

Furthermore, because only a continuous gesture 110 needs to be detected, even if there is some ambiguity in detection of continuous gesture 110, only the gesture 110 needs be re-entered (e.g., redrawn by the user such as by continuing additional lassos until the correct content has been selected) or resolved (e.g., user selection of ambiguity resolving options), as opposed to independent resolution or re-entry of a series of multiple independent gestures as currently required by touch-sensitive devices for many complex tasks (e.g., typing, copy/paste).

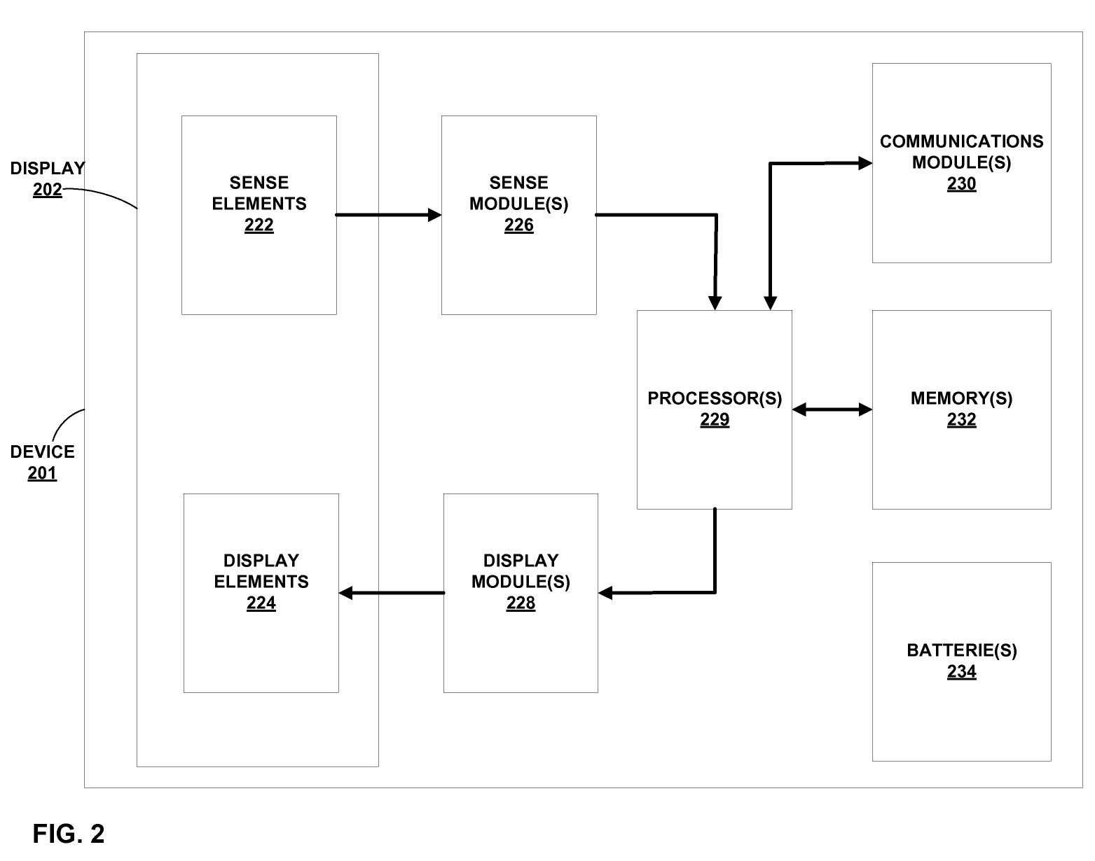

FIG. 2 is a block diagram illustrating one example of a touch-sensitive device 201 configured to detect a continuous gesture such as continuous gesture 110 depicted in FIG. 1. As shown in FIG. 2, device 201 includes a display 202. Display 202 is configured to present images to a user. Display 202 is also configured to detect user interaction with display 202, by bringing a finger or stylus in contact with or in proximity to display 202. As also shown in FIG. 2, display 202 includes one or more display elements 224 and one or more sense elements 222. Display elements 224 are presented at or near a surface of display 202 to cause images to be portrayed via display 202. Examples of display elements 224 may include any combination of light emitting diodes (LEDs), organic light emitting diodes (OLED), liquid crystals (liquid crystal (LCD) display panel), plasma cells (plasma display panel), or any other elements configured to present images via a display. Sense elements 222 may also be presented at or near a surface of display 202. Sense elements 222 are configured to detect when a user has brought a finger or stylus in contact with or proximity to display 202. Examples of sense 222 elements may include any combination of capacitive, resistive, surface acoustic wave, strain gauge, optical imaging, dispersive signal (mechanical energy in glass detection surface that occurs due to touch), acoustic pulse recognition (vibrations caused by touch), or coded LCD (Bidirectional Screen) sense elements, or any other component configured to detect user interaction with a surface of device 201.

Device 201 may further include one or more circuits, software, or the like to interact with sense elements 222 and/or display elements 224 to cause device 201 to display images to a user and to detect a continuous gesture (e.g., gesture 110 in FIG. 1) according to the techniques of this disclosure. For example, device 201 includes display module 228. Display module 228 may communicate signals to display elements 224 to cause images to be presented via display 202. For example, display module 228 may be configured to communicate with display elements 224 to cause the elements to emit light of different colors, at different frequencies, or at different intensities to cause a desired image to be presented via display.

Device 201 further includes sense module 226. Sense module 226 may receive signals indicative of user interaction with display 202 from sense elements 222, and process those signals for use by device 201. For example, sense module 226 may detect when a user has made contact with display 202, and/or when a user has ceased making contact (removed a finger or stylus) with display 202. Sense module 226 may further distinguish between different types of user contact with display 202. For example, sense module 226 may distinguish between a single touch gesture (one finger or one stylus), or a multi-touch gesture (multiple fingers or styli) in contact with display 202 simultaneously. In other examples, sense module 226 may detect a length of time that a user has made contact with display 202. In still other examples, sense module 226 may distinguish between different gestures, such as a single touch gesture, a double or triple (or more) tap gesture, a swipe (moving one or more fingers across display), a circle (lasso) on display, or any other gesture performed via display 202.

As also shown in FIG. 2, device 201 includes one or more processors 229, one or more communications modules 230, one or more memories 232, and one or more batteries 234. Processor 229 may be coupled to sense module 226 to control detection of user interaction with display 202. Processor 229 may further be coupled to display module 228 to control the display of images via display 202. Processor 229 may control the display of images via display 202 based on signals indicative of user interaction with display 202 from sense module 236, for example when a user draws a gesture (e.g., continuous gesture 210 in FIG. 1), that gesture may be reflected on display 202.

Processor may further be coupled to memory 232 and communications module 230. Memory 232 may include one or more of a temporary (e.g., volatile memory) or long term (e.g., non-volatile memory such as a computer hard drive) memory component. Processor 229 may store data used to process signals from sense elements 222, or signals communicated to display elements 224 to control functions of device 201. Processor 229 may further be configured to process other information for operation of device 201, and store data used to process the other information in memory 232.

Processor 229 may further be coupled to communications module 230. Communications module 230 may be a device configured to enable device 201 to communicate with other computing devices. For example, communications module may be a wireless card, Ethernet port, or other form of electrical circuitry that enables device 201 to communicate via a network such as the Internet. Via communications module 230, device 201 may communicate via a cellular network (e.g., a 3G network), a local wireless network (e.g., a Wi-Fi network), or a wired network (Ethernet network connection). Communications module 230 may further enable other types of communications, such as Bluetooth communication.

In the example of FIG. 2, device 201 further includes one or more batteries 234. In some examples in which device 201 is a portable device (e.g., cell phone, laptop, smartphone, netbook, tablet computer, etc.), device 201 may include battery 234. In other examples in which device 201 is a non portable device (e.g., desktop computer, television display), battery 234 may be omitted from device 201. Where included in device 201, battery 234 may power circuitry of device 201 to allow device 201 to operate in accordance with the techniques of this disclosure.

The example of FIG. 2 shows sense module 226 and display module 228 as separate from processor 229. In some examples, sense module 226 and display module 228 may be implemented in separate circuitry from processor (sense module 236 may be implemented separate from display module 228 as well). However, in other examples, one or more of sense module 226 and sensor module 228 may be implemented via software stored in memory 232 and executable by processor 229 to implement the respective functions of sense module 226 and display module 228. Furthermore, the example of FIG. 2 shows sense element 222 and display elements 224 as formed independently via display 202. However, in some examples, one or more sense elements 222 and display elements 224 may be formed of arrays including multiple sense and display elements, which are interleaved in display 202. In some examples, both sense 222 and display 224 elements may be arranged to cover an entire surface of display 201, such that images may be displayed and user interaction detected across at least a majority of display 202.

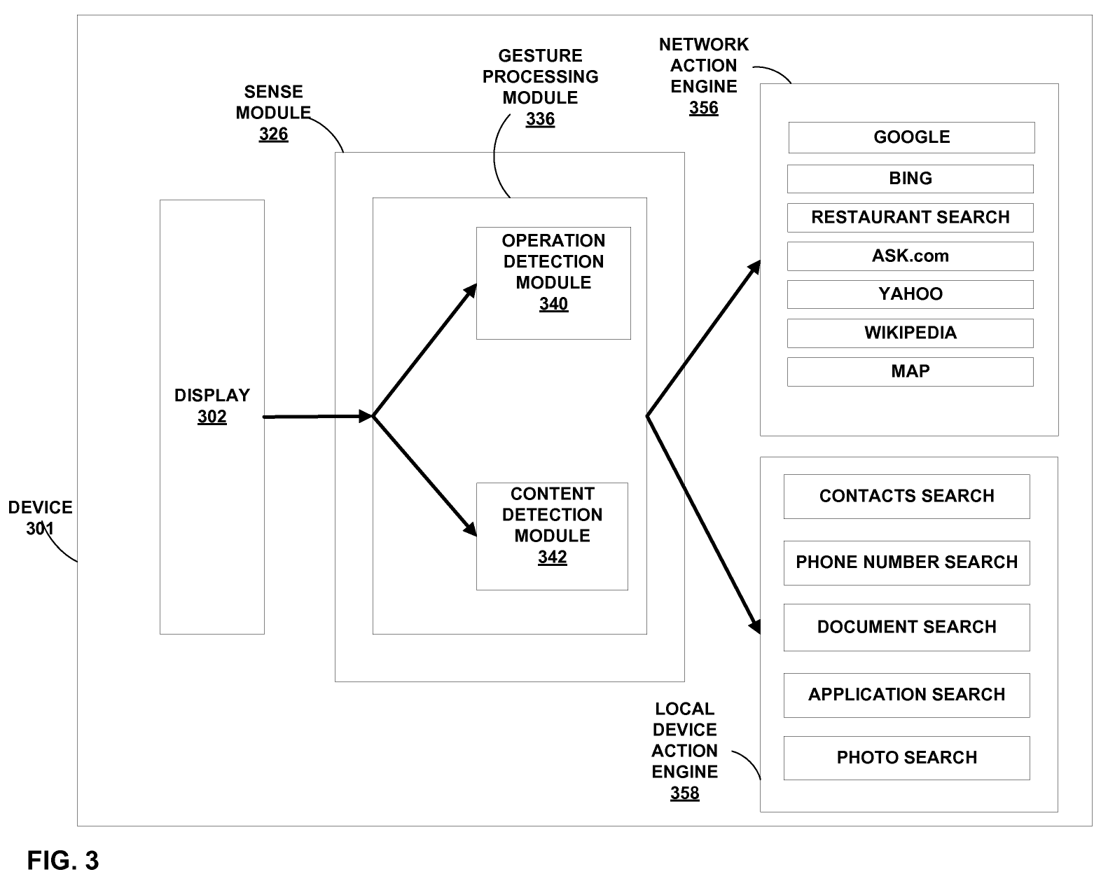

FIG. 3 is a block diagram that illustrates a more detailed example of functional components of a touch-sensitive device 301 configured to detect a continuous gesture according to the techniques of this disclosure. As shown in FIG. 3, display 302 is coupled to sense module 326. Sense module 326 may generally be configured to process user input based on user interaction with display 302. Sense module 326 may be specifically configured to detect a continuous gesture (e.g., gesture 110 of FIG. 1) that includes first 112 and second 114 portions as described above. To do so, sense module 326 includes gesture processing module 336. Gesture processing module 336 includes an operation detection module 340 and a content detection module 342.

Operation detection module 340 may detect a first portion 112 of a continuous gesture 110 as described herein. Content detection module 342 may detect a second portion 114 of a continuous gesture 110 as described herein. For example operation detection module 340 may detect when a user has drawn a character, or letter, on display 302. Operation detection module 340 may identify that a character has been drawn on display 302 based on detection of user input, and compare detected user input to one of more pre-determined shapes that identify the user input as a drawn character. For example, operation detection module 340 may compare a user drawn a “g” to one or more predefined characteristics known for a “g” character, and correspondingly identify that the user has drawn a “g” on display 302. Operation detection module 340 may also or instead be configured to detect when certain portions (e.g., upward swipe, downward swipe) for a particular character have been drawn on display, and that a combination of multiple distinct gestures represents a particular character.

Similarly, content detection module 342 may detect when a user has drawn a second portion 114 of continuous gesture 110 on display 302. For example, content detection module 342 may detect when a user has drawn a circle (or oval or other similar shape), or lasso, at least partially surrounding one or more images representing content 120 presented via display 302. In one example, content detection module 342 may detect that a second portion 114 of continuous gesture 110 has been drawn on display 302 when operation detection module 340 has already recognized that a first portion 112 of continuous gesture 110 has been drawn on display 302. Furthermore, content detection module 342 may detect that a second portion 114 of continuous gesture 110 has been drawn on display 302 when the first portion 112 has been drawn without the user releasing contact with the display 302 between the first 112 and second gestures 114. In other examples, a user may first draw second portion 114 and then draw first portion 112. According to these examples, operation detection module 340 may detect first portion 112 when second portion 114 has been drawn without the user releasing contact with display 302. For example, partial completion of a lasso gesture portion provides a simple methodology to distinguish the second gesture portion from the first gesture portion. If the second gesture portion is a lasso, then the lasso (partial, complete, or repeated) may form an approximation of an oval, such that gesture portions outside the oval are treated as part of the first gesture portion (that may be a character). Similarly, known end strokes or gesture portions outside of recognized characters can be treated as another gesture portion. As noted previously, a gesture portion can be recognized by character similarity, stroke recognition, or other gesture recognition methods.

As shown in FIG. 3, based on operation of gesture processing module 336, one or more functions indicated by the first portion 112 of the continuous gesture 110 may be executed based on content 120 indicated by second portion 114 of continuous gesture 110. As shown in FIG. 3, gesture processing module 336 is coupled to one or more of a network action engine 356 and a local device action engine 358. Network action engine 356 may be operable to execute one or more functions associated with a network connection to access information. For example, network action engine 356 may supply content 120 detected by content detection module 342 to one or more uniform resource locators (URLs) or APIs that host search engines for particular content.

In one example, where a “g” character represents a Google search, network action engine 356 may cause execution of a search via the search engine available at www.google.com. In other examples, other characters drawn as a first portion 112 of continuous gesture 110 may cause execution of different search engines at different URLs. For example, a “b” character may cause execution of a search by Microsoft's Bing. A “w” gesture portion may cause execution of a search via www.wikipedia.org. An “r” gesture portion may cause execution of a search for available restaurants via one or more known search engines catered to restaurant location. An “m” gesture portion may cause execution of a map search (e.g., www.google.com/maps). An “a” gesture portion may cause execution of a search via www.ask.com. Similarly, a “y” gesture portion may cause execution of a search via www.yahoo.com.

The examples provided above of functionality that may be executed by network action engine 356 based on a first portion 112 of a continuous gesture 110 are intended to be non-limiting. Any character, whether a Latin language-based character or a character from some other language, may represent any functionality to be performed via device 102 according to the techniques described herein. In some examples, specific characters for first portion 112 may be predetermined for a user. In other examples, a user may be provided with an ability to select what characters represent what functionality, and as such gesture processing module 336 may correspondingly detect the particular functionality associated with a user-programmed character as the first portion 112 of continuous gesture 110.

Local device action engine 358 may initiate functionality local to device 301. For example, local device action engine 358 may, based on detection of continuous gesture 110, cause a search or execution of an application via device 301, e.g., to be executed via processor 229 illustrated in FIG. 2. FIG. 3 illustrates some examples of local searches that may be performed based on detection of continuous gesture 110. For example, detection of a continuous gesture 110 that includes a “c” character for first portion 112 may cause a search of a user's contacts. A “p” character for first portion 112 may cause a search of the user's contacts with only a phone number returned if a match is found. A “d” first portion 112 may cause a search of documents stored in memory on device 301. An “a” first portion 112 may cause a search of applications on a user's device 301.

In an alternative example, a “p” first portion 112 may cause a search of photos on device 301. In other examples not depicted, a first portion 112 of a continuous gesture may be tied to one or more applications that may be executed via device 301 (e.g., by processor 229 or by another device coupled to device 301 via a network). For example, if device 301 is configured to execute an application that causes a map to be displayed on display 302, an “m” first portion 112 of a continuous gesture 110 may cause local device action engine 358 to display a map based on content selected via second portion 114.

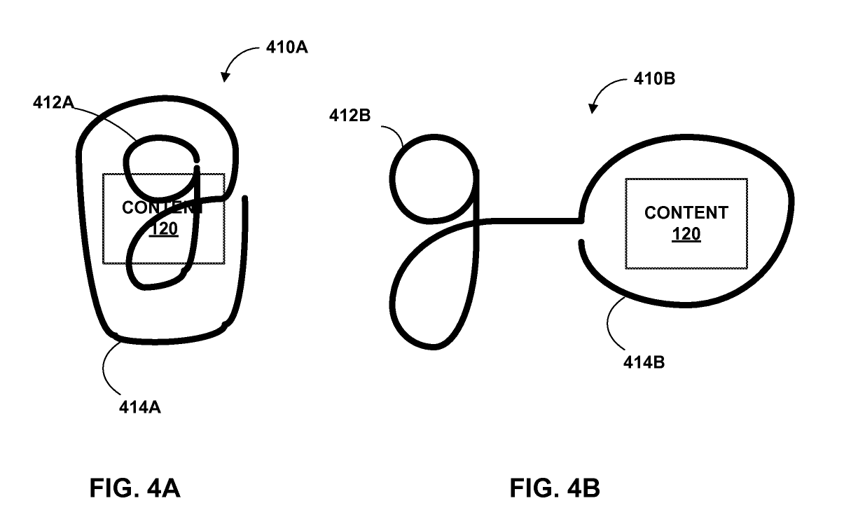

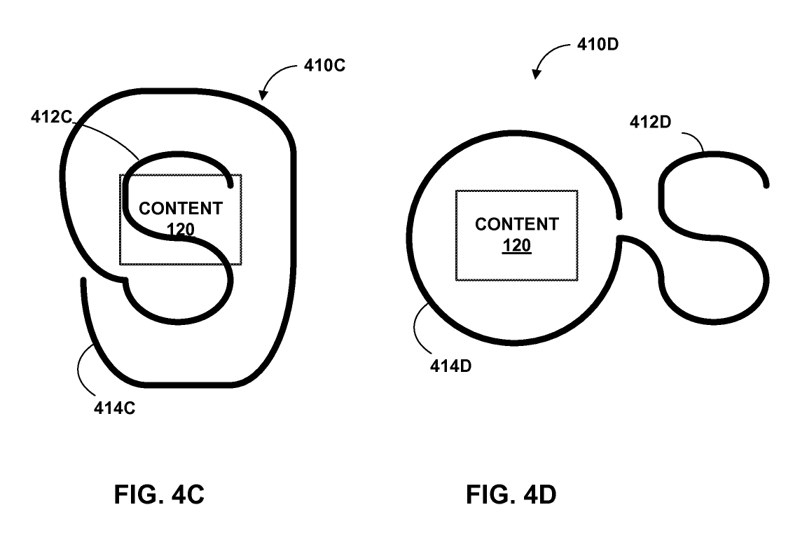

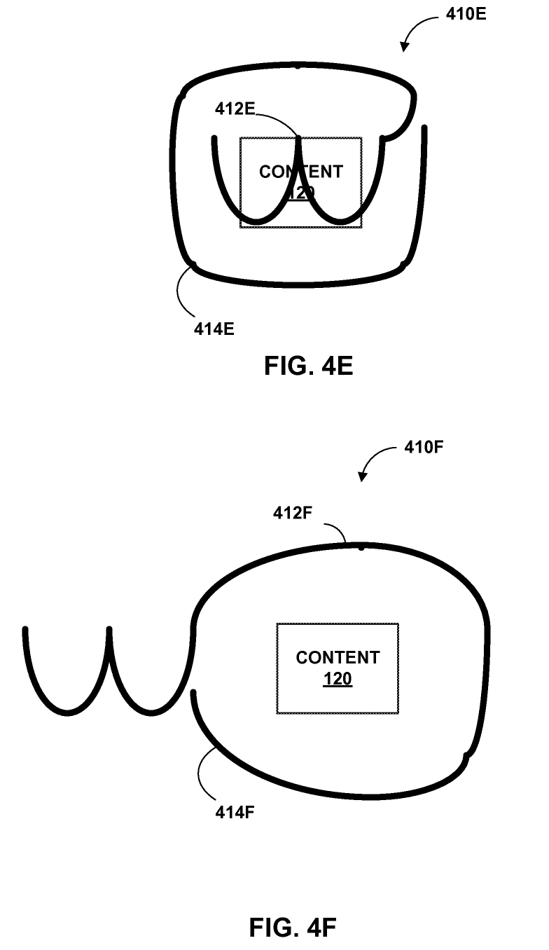

FIGS. 4A-4F are a conceptual diagrams that illustrates various examples of continuous gestures 410A-410F (collectively “continuous gestures 410”) that may be detected according to the techniques of this disclosure. For example, continuous gesture 410A of FIG. 4A is similar to continuous gesture 110 as illustrated in FIG. 1. Continuous gesture 410A shows a first gesture portion 412A that is a “g” character. A second portion 414A is drawn surrounding content 120, and also surrounding the first portion 112A. Continuous gesture 410B of FIG. 4B includes a second portion 414B that, instead of surrounding first portion 412B, surrounds content 120 at a different position on a display than first portion 412B. As shown in FIG. 4C, continuous gesture 410C shows a first portion 412C that is an “s” character. Continuous gesture 410C may indicate a search in general. In some examples, when a user releases contact with a display when drawing continuous gesture 410C, detection of gesture 410C may cause options to be provided to the user to select a destination (e.g., a URL) for a search operation to be performed based on content indicated by second portion 414C.

For example, a user may be presented with options to search local to device, to search via a particular search engine (e.g., Google, Yahoo, Bing search), or to search for specific information (e.g., contacts, phone number, restaurants). As shown in FIG. 4D, continuous gesture 410D illustrates an alternative gesture that includes a first portion 412D that is an “s” character. In this example, second portion 414 does not surround first portion 412D. Also, continuous gesture 410D shows second portion 414D extending to the left of first portion 412D. As such, continuous gesture 410D illustrates that second portion 414 of a continuous gesture 410 need not be arranged in any particular position with respect to first portion 412. Instead, second portion 414 may be drawn anywhere on a display with respect to a position of first portion 412. As shown in FIGS. 4E and 4F, continuous gestures 410E and 410F each illustrate a continuous gesture 410 that includes a first portion that is a “w” character. The “w” character may indicate, in one example, that a search is to be performed based on content 120 via the URL at www.wikipedia.org.

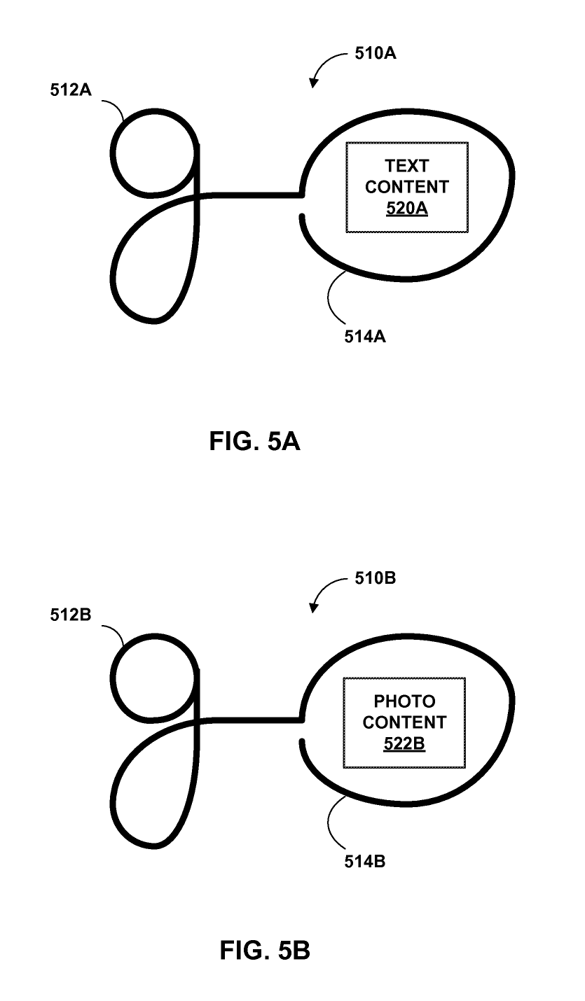

FIG. 5 is a conceptual diagram that illustrates one example of continuous gestures 510A, 510B that may be utilized to initiate functionality based on text content 520A, photo content 520B (e.g., photographic depiction, video, or other like content), or both text and photo content presented via a display 102 of a touch-sensitive device 101. As shown in FIG. 5, a second portion 514 of a continuous gesture 510 may encircle, or lasso, multiple types of content. The resulting content may be highlighted or visually shown as selected by the lasso. For example, gesture 510A is shown with second portion 514A encircling textual content, such as text displayed on a web page (e.g., a news article). In other examples, a continuous gesture 510B may include a second portion 514B that encircles a photo, a video, or a portion of a photo or video to select content for functionality indicated by first portion 512B. In some examples, encircling a photo 514B may cause an automatic determination of what content is indicated by photo content 520. In some examples, photo content 520 may include metadata, or ancillary data associated with a photo or video that identifies the content of the photo or video. For example, if a photo captures an image of a golden retriever, the photo may include metadata that indicates that the photo is an image of a golden retriever. As such, gesture processing module 336 may initiate functionality indicated by first portion 512B of continuous gesture 510B based on the phrase “golden retriever.”

In other examples, gesture processing module 336 may determine content indicated by second portion 512B of continuous gesture 510B based on automated determination of photo or video content. For example, gesture processing module 336 may be configured to compare an image (e.g., an entire photo, portion of a photo, entire video, portion of a video), by comparing the image to one or more other images for which content is known. For example, where a photo includes an image of a golden retriever, that photo may be compared to other images to determine that the image is of a golden retriever. Accordingly, functionality indicated by first portion 512B of gesture 510B may be executed (such as at a image search server as noted below) based on the automatically determined content associated with an image (photo, video) indicated by second portion 514B instead of, or along with, text. As noted below, surrounding displayed content can also be used to further give context to results.

In still other examples, facial or photo/image recognition may be used to determine content 522. For example, gesture processing module 336 may analyze a particular image from a photo or video to determine defining characteristics of a subject's face. Those defining characteristics may be compared to one or more predefined representations of characteristics (e.g., shape of facial features, distance between facial features) that may identify the subject of the photo. For example, where a photo is of a person, gesture processing module 336 may determine defining characteristics of the image of the person, and search one or more databases to determine the identity of the subject of the photo. Personal privacy protection features can be implemented in such facial and person recognition systems, such that a gesture can be provided for, for example, by selecting oneself in a particular image to be identified or to eliminate an existing self-identification.

In other examples, gesture processing module 336 may perform a search for images to determine content associated with an image indicated by second portion 512B of gesture 510B. For example, gesture processing module may a search for other photos e.g., available over the Internet, from social networking services (e.g., Facebook, Myspace, Orkhut), photo management tools (e.g., Flickr, Picasa) or other locations. Gesture processing module 336 may perform direct comparisons between searched photos and an image indicated by gesture 510B. In another example, gesture processing module 336 may extract defining characteristics from searched photos, and compare those defining characteristics to an indicated image to determine the subject of the image indicated by second gesture 514B.

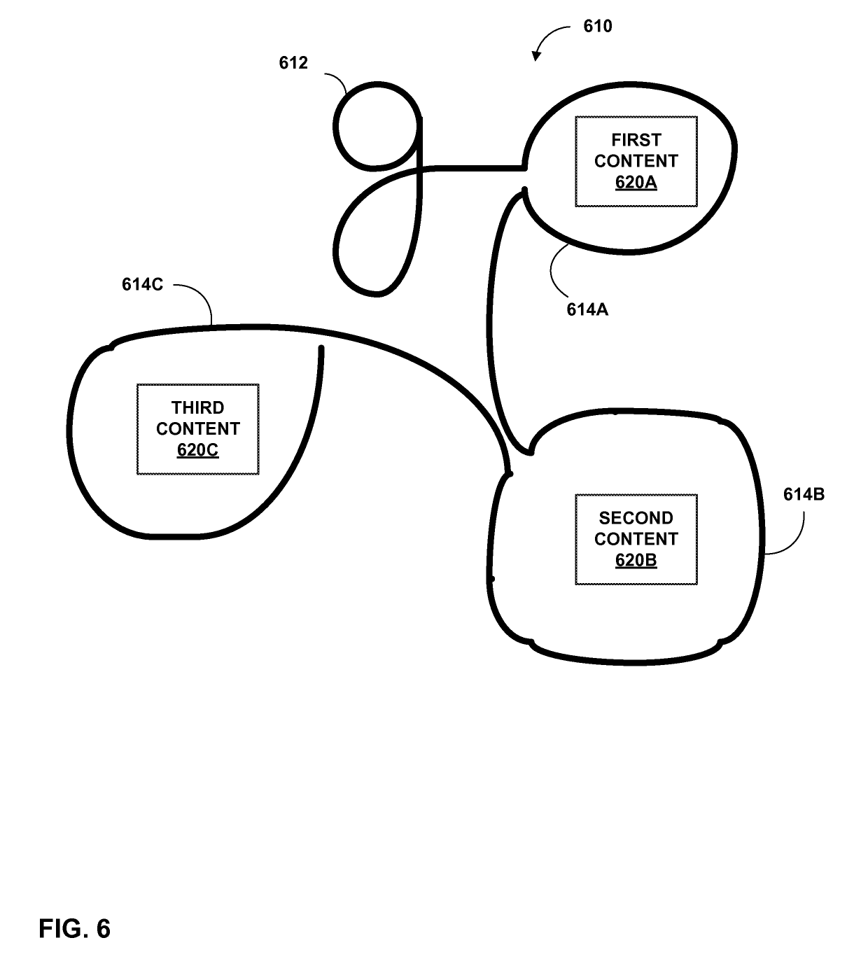

FIG. 6 is a conceptual diagram that illustrates another example detection of a continuous gesture 610 consistent with the techniques of this disclosure. As shown in FIG. 6, a user has, via a device display (e.g., display 102 in FIG. 1), drawn a first portion 612 as a character “g.” As discussed above, the “g” character may, in one example, indicate that the user seeks to initiate a search via the search engine available at the URL www.google.com or via related search API. A user has further drawn a second gesture portion 614 that includes a first content lasso 614A. The first content lasso indicates a first content 620A to be searched via the search engine.

As also shown in FIG. 6, the user has drawn second and third content lassos 614B and 614C surrounding second content 620B and 620C, respectively. Accordingly, gesture processing module 336 may detect the multiple content lassos 614A-614C over the same content (to clarify the content to be searched) or over multiple pieces of content, and initiate a search based on a combination of one or more of contents 620A-602C. For example, if a user has a news article open that displays the words “restaurant” and “Thai food” and a map of New York City, a user may, via continuous gesture 610, cause a search to be performed on the phrase “Thai food restaurant New York City.”

The example illustrated in FIG. 6 may be advantageous in certain situations, because continuous gesture 610 enables a user a heightened level of flexibility to initiate functionality based on user-selected content. According to known touch-sensitive devices, a user would need to go through several copy-and-paste operations, or type in the terms of a particular search, to execute similar functionality. Both of these options may be cumbersome, time consuming, difficult, and/or frustrating for a user. By providing a touch-sensitive device configured to detect a continuous gesture 610 as described herein, a user's ability to easily and quickly initiate more complex tasks (e.g., a search operation) may be improved.

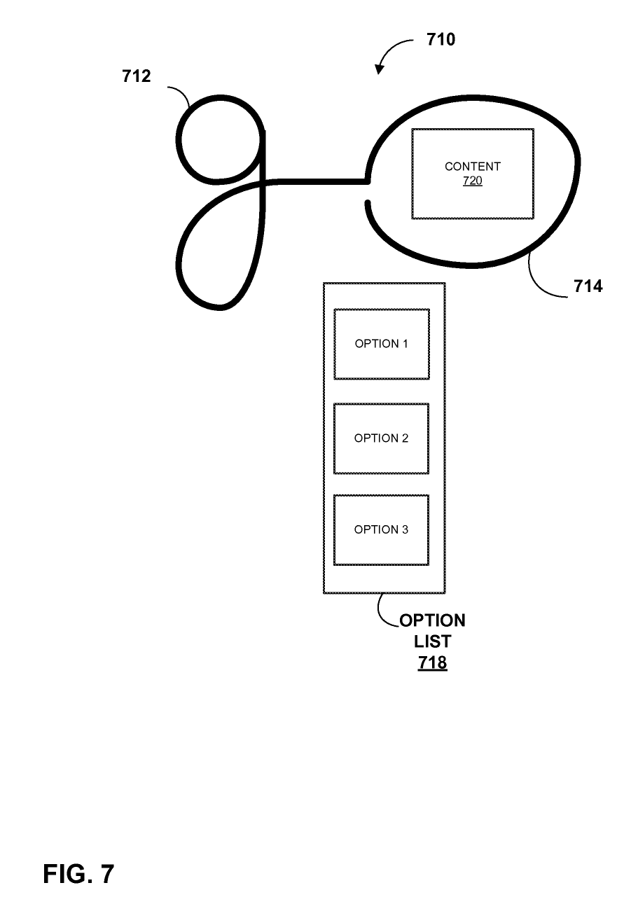

FIG. 7 is a conceptual diagram that illustrates detection of a continuous gesture 710 consistent with the techniques of this disclosure. FIG. 7 illustrates that a continuous gesture 710 has been drawn on a touch-sensitive device. As discussed above, the continuous gesture includes a first portion 712 that identifies functionality to be performed, and a second portion 714 that indicates content that the functionality to be performed is based on. As also shown in FIG. 7, a touch-sensitive device (e.g., device 101 in FIG., 1) may, in response to detection of completion of gesture 710 (e.g., a user has drawn second portion and released a finger or stylus from a touch-sensitive surface, or a user has held a finger or stylus in place on the display such as to initiate options), provide a user with an option list 718 that includes options for execution of the functionality indicated by first gesture portion 712.

For example, where a user has selected content 720 (or multiple content with several lassos as shown in FIG. 6) and indicated a search with a continuous gesture 710, device 101 may present, via display 102, various options for performing the search. Device 101 may, based on user selection of content, automatically determine options that a user may likely want to search based on the indicated content. For example, if a user selects the text “pizza,” or a photo of a pizza, device 101 may determine restaurants near the user (where device 101 includes global positioning system (GPS) functionality, a user's current position may indicate where the user is located), and present web pages or phone numbers associated with those restaurants for selection.

Device 101 may instead or in addition provide a user with an option to open a Wikipedia article describing the history of the term “pizza,” or a dictionary entry describing the meaning of the term “pizza.” Other options are also contemplated and consistent with this disclosure. In still other examples, based on user selection of content via a continuous gesture, device 101 may present to a user other phrases or phrase combinations that the user may wish to search for. For example, where a user has selected the term pizza, a user may be provided one or more selectable buttons to initiate a search for the terms “pizza restaurant,” “pizza coupons,” and/or “pizza ingredients.”

The examples described above are directed to the presentation of options to a user based on content and/or functionality indicated by a continuous gesture 710. In other examples, options may be presented to a user based on more than just the content/functionality indicated by gesture 710. For example, device 101 may be configured to provide options to a user also based on a context in which particular content is displayed. For example, if a user circles the word “pizza” in an article about Italy, options presented to the user in response to the gesture may be more directed towards Italy. In other examples, device 101 may provide options to a user based on words, images (photo, video) that are viewable along with user selected content, such as other words/photos/videos displayed with the selected content.

By combining a continuous gesture 710 with the presentation of options to a user as described with respect to FIG. 7, such as based on a user hold at the end of the continuous gesture (as noted above), a user experience via a touchscreen device may be improved. Because user selection of a button presented via a display is a relatively unambiguous gesture easily detectable via a touch-sensitive device, a user may maintain customizability associated with classical keyboard and mouse/trackpad mechanisms for user input (e.g., by modifying a word or phrase copied and pasted into a search browser window via a keyboard), by simple continuous touch gesture 710.

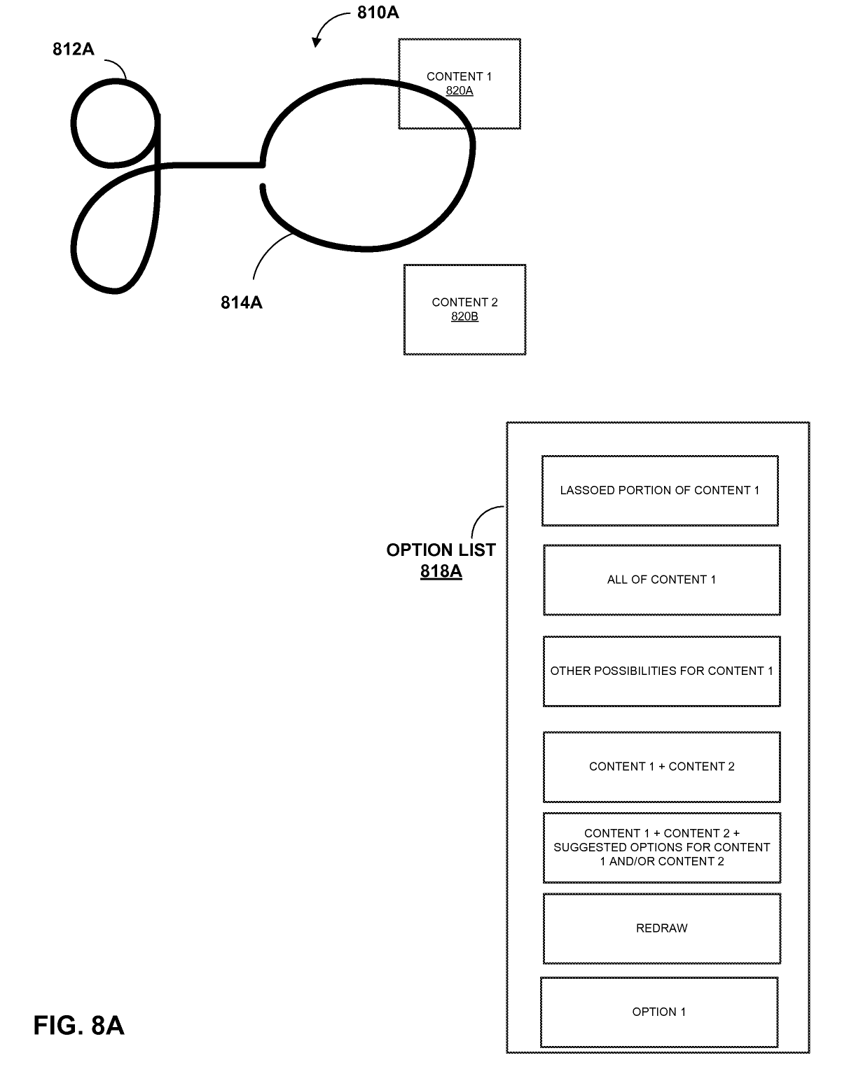

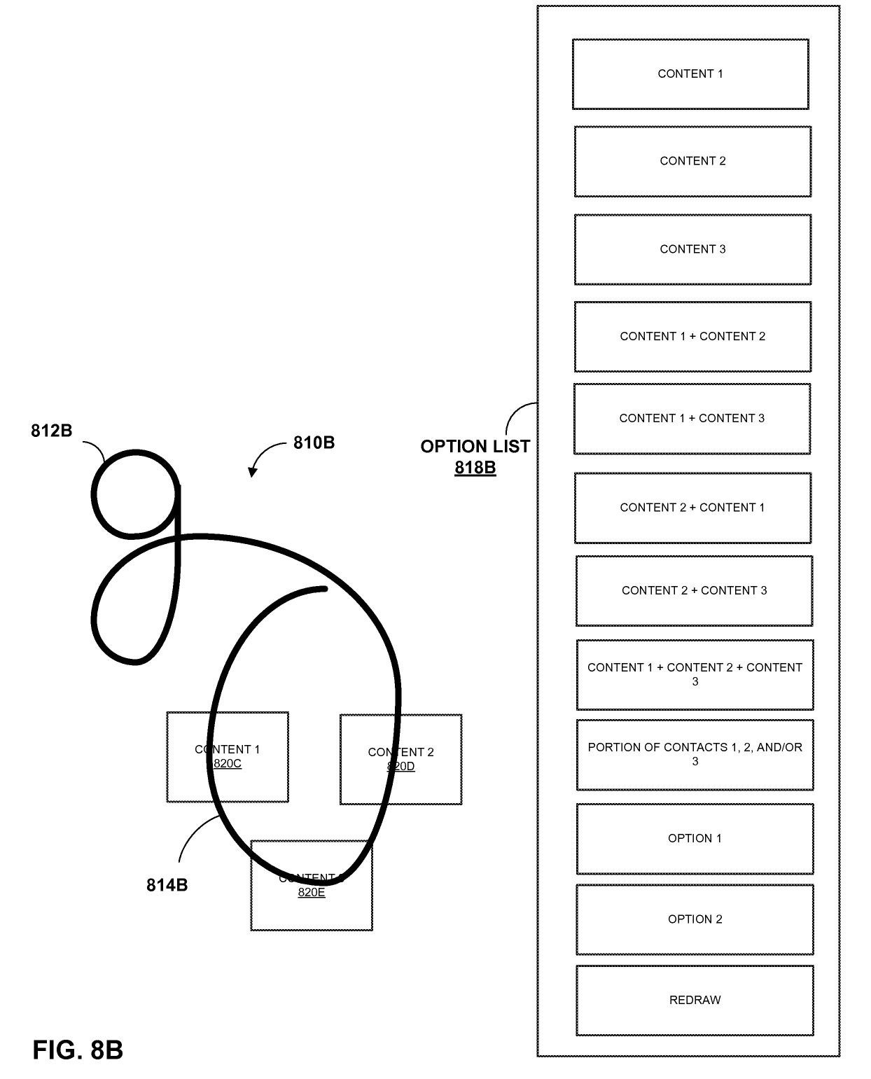

FIG. 8A is a conceptual diagram that illustrates one example of detection of a continuous gesture consistent with the techniques of this disclosure. FIG. 7 shows one example of continuous gesture detection where a user is provided with options for a search based on content selected by a user. FIG. 8A depicts detection of a continuous gesture that is relatively ambiguous, and presenting, via display 102 of device 101, options for a user to clarify the detected ambiguous gesture. As described herein, an ambiguous gesture refers to a gesture for which device 101 may be unable to definitively determine what content (or functionality) a user intended to select via a continuous gesture.

For example, as shown by gesture 810A in FIG. 8A, a user has drawn a second portion 814A only surrounding a portion of content 820A. As such, detection of gesture 810A may be somewhat ambiguous, because device 101 may be unable to determine whether the user desired to initiate a search (as may be indicated by first portion 812A) based on only a portion of a word, phrase, photo, or video presented by content 820A, or whether the user intended to initiate a search based on the entire word, phrase, photo, or video of content 820A.

In one example, as depicted in FIG. 8A, in response to detection of ambiguous gesture 810A, device 101 may present to a user various options (e.g., an option list 818A as shown in FIG. 8A) to resolve the ambiguity. For example, device 101 may present to a user various combinations of words, phrases, photos, or video for which the user may have desired to search. For example, if the content 820A was text stating the word “Information,” and the user circled only the letters “Infor” of the word information, device 101 may present to the user options to select one of “Info,” “Inform,” or “Information.”

In other examples, device 101 may provide an option list based instead or in addition on a context in which content 820A is presented. For example, as shown in FIG. 8 content 820B is presented in conjunction with content 820A. Content 820B may be a word or phrase arranged close to content 820A. In some examples, device 101 may utilize content 820B to determine what options to provide to a user in response to detected ambiguity. In other examples, device 101 may use other forms of contextual content, e.g., a title of a newspaper article, nearby content or other document that content 820A is presented in or with, to determine options to present to the user to resolve any ambiguity in detection of continuous gesture 810A.

FIG. 8B also depicts that a user has drawn a first portion 812B of a continuous gesture 810B, and a second portion 814B that encircles, or lassos, portions of a plurality of content 820D, 820E, 820F. Gesture processing module 336 (as depicted in FIG. 3) may recognize that a user has provided a second gesture portion 814B that device 101 is unable to definitively determine what content (or functionality) a user intended to select via the continuous gesture.

As such, in response to detecting that a user has completed continuous gesture 810B (e.g., by detecting that a user has severed contact with a touch-sensitive surface of device 101, or that the user has “held” contact for a predetermined amount of time), provide to the user option list 818B that includes various selectable options for the user to clarify identified ambiguity. As shown in FIG. 8B, in response to detection that the user has lassoed portions of contents 820A-820C, option list 818B provides a user with various combination of 820C-820E for which functionality associated with the first portion 812B of gesture 810B is based.

For example, as shown in FIG. 8B, a user is provided with selectable buttons to choose content 820C, 820D, or 820E individually, combinations of two of the three contents 820C-820E, or all three contents 820C-820E in combination. A user may also be presented an option to redraw the second portion 814B of continuous gesture 810B. In one example, such an option may be provided with a “redraw” button presented via option list 818B. In other examples, a “redraw” option may be presented to a user via modification of a representation of a drawn/detected gesture 810B, such as causing the drawn gesture or the selected content to change in visual intensity or to flash, thereby indicating that recognizable content or functionality has not been identified by gesture processing engine 336, and enabling a user to redraw the gesture 810B or one of the first and second portions 812B, 814B of gesture 810B.

In still other examples, as also shown in FIG. 8, option list 818B may further provide a user with options for particular functionality as described above with respect to FIG. 7. In other examples, a user may first be provided an ability to resolve ambiguity in detection of a continuous gesture 810B, and then a user may be provided with an option list 718 as shown in FIG. 7 to select options associated with functionality indicated by continuous gesture 810B.

As discussed above, this disclosure is directed to improvements in user interaction with a touch-sensitive device. As described above, the techniques of this disclosure may provide a user with an ability to initiate more complex tasks via interaction with a touch-sensitive device in a continuous gesture. Because continuous gestures are utilized to convey user intent for a particular task, any ambiguity in detection (as described with respect to FIG. 8) of user intent may be resolved once for the continuous gesture. As such, a user experience in operating a touch-sensitive device may be improved, because the input of commands to the device and detection of those commands is simplified.

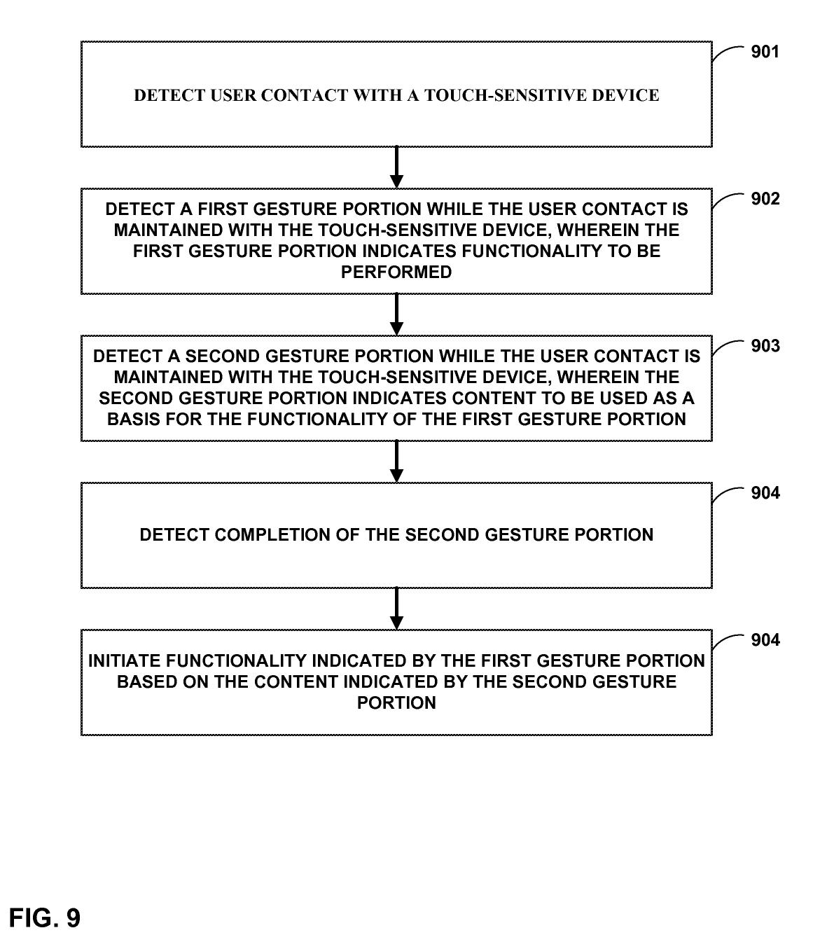

FIG. 9 is a flow chart diagram illustrating one example of a method of detecting a continuous gesture via a touch-sensitive device consistent with the techniques of this disclosure. In some examples, the method of FIG. 9 may be implemented or performed by a touch-sensitive device, such as any of the touch-sensitive devices described herein. As shown in FIG. 9, the method includes detecting user contact with a touch-sensitive device 101 (901). The method further includes detecting a first gesture portion 112 while the user contact is maintained with the touch-sensitive device 101 (902). The first gesture portion 112 indicates functionality to be performed. The method further includes detecting one or more second gesture portions 114 while the user contact is maintained with the touch-sensitive device (903). The second gesture portion 114 indicates content to be used as a basis for the functionality of the first gesture portion 112. The method further includes detecting completion of the second gesture portion 114 (904).

In one example, detecting completion of the second gesture portion 114 includes detecting a release of the user contact with the touch-sensitive device 101. In another example, detecting completion of the second gesture portion 114 includes detecting a hold at an end of the second gesture portion, wherein the hold maintains the user contact at substantially a fixed location on the touch-sensitive device 101 for a predetermined time. In one example, the method further includes providing selectable options for the functionality indicated by the first gesture portion 112 or the content indicated by the second gesture portion 114 responsive to detecting completion of the second gesture portion 114. In another example, the method further includes identifying ambiguity in one or more of the first gesture portion 112 and the second gesture portion 114, and providing a user with an option to clarify the identified ambiguity. In one example, providing the user with an option to clarify the identified ambiguity includes providing the user with selectable options to clarify the identified ambiguity. In another example, providing the user with option to clarify the identified ambiguity includes providing the user with an option to redraw one or more of the first gesture portion 112 and the second gesture portion 114.

The method further includes initiating the functionality indicated by the first gesture portion 112 based on the content indicated by the second gesture portion 114 (904). In one non-limiting example, detecting the first gesture portion 112 may indicate functionality in the form of a search. In one such example, detecting the first gesture portion 112 may include detecting a character (e.g., a letter). According to this example, the second gesture portion 114 may indicate content to be the subject of the search. In some examples, the second gesture portion 114 is a lasso-shaped selection of content displayed via a display 102 of the touch-sensitive device 101. In some examples, the second gesture portion may include multiple lasso-shaped selections of multiple content displayed via a display 102 of the touch-sensitive device 101. In one example, the second gesture portion 114 may select one or more of text or phrase 520A and/or photo/video 520B content to be searched. In one example, where the second gesture portion selects photo/video content 520B, the touch-sensitive device 101 may automatically determine content associated with a photo/video for which the functionality indicated by the first gesture portion 112 is based.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

Various embodiments of this disclosure have been described. These and other embodiments are within the scope of the following claims.

1. A method, comprising:
detecting user contact with a touch-sensitive device using at least one sensor of the touch-sensitive device;
detecting, using the at least one sensor, a first gesture portion while the user contact is maintained with the touch-sensitive device, wherein the first gesture portion indicates functionality to be performed;
detecting, using the at least one sensor, a second gesture portion while the user contact is maintained with the touch-sensitive device, wherein the second gesture portion indicates content to be used in connection with the functionality indicated by the first gesture portion;
detecting, using the at least one sensor, completion of the second gesture portion; and
initiating the functionality indicated by the first gesture portion in connection with the content indicated by the second gesture portion.

2. The method of claim 1, wherein detecting completion of the second gesture portion includes detecting a release of the user contact with the touch-sensitive device.

3. The method of claim 1, wherein detecting completion of the second gesture portion includes detecting a hold at an end of the second gesture portion, wherein the hold maintains the user contact at substantially a fixed location on the touch-sensitive device for a predetermined time.

4. The method of claim 1, wherein the first gesture portion indicates that the functionality to be performed is a search.

5. The method of claim 1, wherein the second gesture portion indicates content to be searched.

6. The method of claim 1, wherein detecting the second gesture portion includes detecting a lasso-shaped selection of content displayed via a display of the touch-sensitive device.

7. The method of claim 6, wherein detecting the lasso-shaped selection of content displayed via the display of the touch-sensitive device includes detecting the lasso-shaped selection of text or a phrase presented via the display of the touch-sensitive device.

8. The method of claim 6, wherein detecting the lasso-shaped selection of content displayed via the display of the touch-sensitive device includes detecting the lasso-shaped selection of at least a portion of at least one photo or video presented via the display of the touch-sensitive device.

9. The method of claim 8, further comprising:
automatically determining content associated with the at least one image.

10. The method of claim 1, wherein detecting the first gesture portion includes detecting a character.

11. The method of claim 10, wherein detecting a character includes detecting a letter.

12. The method of claim 1, further comprising:
detecting completion of the second gesture portion; and
providing selectable options for the functionality indicated by the first gesture portion or the content indicated by the second gesture portion responsive to detecting completion of the second gesture portion.

13. The method of claim 1, further comprising:
detecting completion of the second gesture portion;
identifying ambiguity in one or more of the first gesture portion and the second gesture portion; and
providing a user with an option to clarify the identified ambiguity.

14. The method of claim 13, wherein providing the user with the option to clarify the identified ambiguity includes providing the user with selectable options to clarify the identified ambiguity.

15. The method of claim 13, wherein providing the user with the option to clarify the identified ambiguity includes providing the user with an option to redraw one or more of the first gesture portion and the second gesture portion.

16. The method of claim 1, wherein detecting the second gesture portion includes detecting multiple lasso-shaped selections of content displayed via a display of the touch-sensitive device.

17. A touch-sensitive device, comprising:
a display configured to present at least one image to a user;
a touch-sensitive surface;
at least one sense element disposed at or near the touch-sensitive surface and configured to detect user contact with the touch-sensitive surface;
means for determining a first gesture portion while the at least one sense element detects the user contact with the touch-sensitive surface, wherein the first gesture portion indicates functionality that is to be initiated;
means for determining a second gesture portion while the at least one sense element detects the user contact with the touch-sensitive surface, wherein the second gesture portion indicates content to be used in connection with the functionality indicated by the first gesture; and
means for initiating the functionality indicated by the first gesture portion in connection with the content indicated by the second gesture portion.

18. The touch-sensitive device of claim 17, wherein the means for determining the first gesture portion comprises means for determining a character drawn on the touch-sensitive surface.

19. The touch-sensitive device of claim 17, wherein means for determining the second gesture portion comprise means for determining a lasso-shaped selection of content displayed via the display of the touch-sensitive device.

20. An article of manufacture comprising a computer-readable storage medium that includes instructions that, when executed, cause a computing device to:
detect user contact with a touch-sensitive device using at least one sensor of the touch-sensitive device;
detect, using the at least one sensor, a first gesture portion while the user contact is maintained with the touch-sensitive device, wherein the first gesture portion indicates functionality to be performed;
detect, using the at least one sensor, a second gesture portion while the user contact is maintained with the touch-sensitive device, wherein the second gesture portion indicates content to be used in connection with the functionality of the first gesture;
detect, using the at least one sensor, completion of the second gesture portion; and
initiate the functionality indicated by the first gesture portion in connection with the content indicated by the second gesture portion.

21. The article of manufacture comprising a computer-readable storage medium of claim 20, wherein instructions, when executed, further cause the computing device to: determine the first gesture portion includes a character drawn on the touch-sensitive surface.

22. The article of manufacture comprising a computer-readable storage medium of claim 20, wherein instructions, when executed, further cause the computing device to: determine the second gesture portion includes a lasso-shaped selection of content displayed via the display of the touch-sensitive device.
